(19) United States
(12) Patent Application Publication
(10) Pub. No.: US 2016/0330591 A1
(43) Pub. Date: Nov. 10, 2016

(54) INDOOR POSITIONING SYSTEM

(71) Applicant: Luis Joaquin Rodriguez, South Orange, NJ (US)

(72) Inventor: Luis Joaquin Rodriguez, South Orange, NJ (US)

(21) Appl. No.: 14/703,801

(22) Filed: May 4, 2015

(51) Int. Cl. H04W 4/04

(52) U.S. Cl. CPC H04W 4/043

(57) ABSTRACT

The present invention disrupts the proverbial axiom: “To think outside the box”. The present invention actually originates from doing the opposite: “To think inside the box”. While outdoor positioning, systems rely on the outer-space-human-made satellite connections and communications with fixed or moving objects on Earth, enabled by the lack of walls and roofs, a so much desired indoor positioning system can not benefit from this premise due to the inherent walls and roofs as the current state of the art demonstrates. The present invention proposes the abstraction of that notion and the circumscription of the targeted indoor site to a specific delimited area. To that end, the site and its floor plan(s) pertinent details are drawn in a proportionally scaled down digital page which may dynamically display the location and movement of any object or person with respect to a predetermined ground zero position, and which can be further monitored in a remote mobile viewing display unit by means of short, mid and long range wireless communication. An important feature of the present invention is the ability to assist the user to navigate from a first location to a second location within an indoor environment. The invention further provides to locate and track the position of any object or person in a three dimensional context within a given site.

### CROSS REFERENCE TO RELATED APPLICATIONS

This application claims the benefit of U.S. Provisional Application Ser. Nos. 61/988,286, filed May 4, 2014, entitled “Indoor Positioning System” and 62/059,995, filed Oct. 5, 2014, entitled “Addendum PPA Moe”, by the present inventor and both of which are herein incorporated by reference.

### FIELD OF THE DISCLOSURE

This invention relates to an electronic positioning system, and particularly to an electronic positioning system that operates indoors, and which will hereinafter be referred to as an “Indoor Positioning System”.

### BACKGROUND OF THE DISCLOSURE

### Description of Prior Art

Outdoor positioning systems are well known, as they have become very popular to aid in road navigation to motorists around the world during the last several years.

These systems are generally referred to as Global Positioning Systems, or “GPS” as they rely on location information sent to the vehicle by artificial satellites placed by man in outer space. The fact that there are no walls or roofs interfering with the signal makes the data transfer fairly reliable and with a reasonable level of accuracy.

Indoor positioning has become the next trend in the field of helping people and objects navigate from point A to point B in an enclosed environment as the system has great applications in marketing, advertising, security and for sure other applications yet to be identified. Malls, airports, hospitals, convention centers, stores, schools, universities, trade shows, are only examples of enclosed locations that may greatly benefit from a reliable indoor positioning system. Similarly to Global Positioning Systems, Indoor Positioning Systems main objective is to guide the user to move from point A to point B. but an indoor environment.

As per an article from ‘Wikipedia’:
“There is currently no de facto standand for an IPS systems design, so deployment has been slow. Nevertheless, there are several commercial systems on the market” (http://en.wikipedia.org/wiki/Indoor_positioning_system)

Existing Indoor Positioning systems or ‘micromapping’ are not very accurate and not very reliable, as they depend on a network of devices, often in cooperation with a regular GPS, to wirelessly locate objects or people inside a building, and guide them in traveling or moving within that building.

These problems are exacerbated whenever the indoor site has multiple levels (floors). This is indeed a mind boggling challenge.

Also as per the ‘Wikipedia’ article mentioned above:
“Systems design shall take into account that an unambiguous locating service will require at least three independent measures per target (see trilateration). For smoothing to compensate for stochastic errors there must be any sound mathematical over-determination that allows for reducing the error budget significantly. Otherwise the system must include information from other systems to cope for physical ambiguity and to enable error compensation. Else the system will fail to provide equal results from independent sensor reads.”

The difficulty in controlling the location of an object or a person indoors, and to assist in traveling from one location to another location is due to the fact that the technologies used are trying to do the task in the frame of the site's ‘global’ location, which is further limited by the enclosed condition, where roofs and walls often interfere and affect the quality of signals.

Additionally, other systems use ad-hoc beacons which are placed at multiple spots of the site to cooperate with a global positioning system where the indoor positioning system is desired. Unfortunately, these systems have also proven complicated, inaccurate and unreliable, for they work in the context of a global environment.

### SUMMARY OF THE DISCLOSURE

In accordance with the present invention, a practical, economical and expedient solution to the Indoor positioning task is to abstract the area of interest from its ‘global’ location and then, define it as an immediate, precise, controllable, digitized ‘document’, in a digital environment, just like any other job is electronically executed in a computer or electronic device in cooperation with software means.

In other words, the approach is to isolate the area, reduce it to a finite size, (“frame it”) and manage it from within, with an ad-hoc software or application as opposed to relying on multiple external and often conflicting and unreliable tools in an infinite context.

The size of the site or compilation of sites will essentially constitute the size of the document, namely, the ‘page size’ in the set up of the project within an electronic or digital environment. This is the first step of the process: To define a page or document size, which delimits the site where the indoor positioning system is to be implemented.

A proportional drawing of each floor plan is provided on a respective page. Thus, if the site only has one level, only one page is provided. If the site has more than one page, page 2, page 3, etc. are provided to indicate a corresponding, floor plan level. Each and all entities, commodities, services, utilities, officers, stores, first aid stations, bathrooms, etc. and their location may be depicted in the lay-outs in a proportional scale. The ability to highlight, pan, zoom in, zoom out, bookmark, “tweet”, etc. different areas of the lay-outs are expressly contemplated. Typically, the lay-out drawings are executed and provided by the site, an agent of the site, or a vendor of the invention.

Just like a mouse cursor in a computer environment can travel across a page or document and indicate a specific location, a ‘cursor’ or icon assigned to a device moving within the site's floor plan can indicate the location on a scaled down screen, in a manner similar to which a GPS device displays the moving or static location of an automobile in an outdoor environment. The similarity of these two systems is restricted to this display and appearance only. The sources of the location information are completely different, and the finite, specific and limited aspect of the site is a fundamental distinction of the present invention.

In the present invention, the cursor in the device is wirelessly linked to a pre-assigned ground zero location within the site, to which all other locations relate to in an X-Y coordinates map within the document. Optionally, an additional Z coordinate relates to the level (floor) in question, when pertinent. The device is carried by the user.

In a first embodiment, the device and its cursor are wirelessly connected to at least one ‘Central Processing Unit’ or transmitter, defining the pre-established ‘ground zero’, via short range, mid range and/or long range signals. The floor plan is mapped by X-Y coordinates. All the devices, by all the users act as peripherals of the ‘Central Processing Unit’ in the site and each registers its individual specific location within said map of coordinates, as it moves or remains static and is visually depicted on the floor plan in a manner similar to how a GPS unit tracks the position of a vehicle. The signals may be transmitted by using systems known on the market as “WiFi”, “Bluetooth®” and/or radio waves. A fairly new system of distance measurement using radio waves that may be adapted for this application is described at http://bit.ly/1IHdXtA

Thus, the controlling unit sends information to the device as to its location in absolute terms and also its location relative to any other location within the same site. This is an electronic equivalent of the “You Are Here” board, with the significant advantage that the user does not have to go to the board. The board is always with the user. The “board”, in fact, is represented by the device.

The term “device” in this disclosure refers to any and all the mobile units used by visitors of the site at any given time. The term “site” in this disclosure refers to the building or structure where the indoor positioning system is implemented.

In a variation of this example the device has an embedded ‘Central Processing Unit’, whereby it operates autonomously, without any connection to a remote Central Processing Unit’ and still linked, to a predetermined ground zero location within the site. This ground zero may be defined by an ad-hoc beacon.

In an alternate version, the page setup is obviated, and it is automatically defined upon finalizing the tracing of the lay-out of the site. In other words, the most outer perimeters of the lay-out act as the page boundaries. A ground zero location may be assigned by the user or may be defaulted to a specific spot, e.g.: the lower left corner of the lay-out.

Depending on the specific venue, the system may be implemented in a number of ways. The following are some examples that should not be construed as exhaustive, since other approaches may be used within the scope of the invention:
a, The “device” is provided by the site. For instance, the device is incorporated in a shopping cart, a shopping basket, etc. that is provided by the site. In these cases, the site may discretionarily provide means to deter theft or inadvertent take out of the device.
b. A device is loaned to the user while visiting the site. A refundable deposit may be imposed so the user is encouraged to return it. Alternatively, an inexpensive device is given to the user, and a monetary credit offered towards the purchase of a good or service upon the return of the device.
c. A disposable device may be provided by the site.
d. The “device” is provided by the user in the form of an existing smart phone or similar portable electronic apparatus. Before or upon entering the site, user is invited to download or upload an application to her smart phone or similar mobile device, via internet or software in portable media, after which, user may access and control positioning information. Within this option, there might additionally be multiple stations throughout the site where the user can scan/download/install the application with the lay-out of the site and the positioning features.

An important advantage of this system is that it contemplates a three dimensional positioning system as it removes any ambiguity or uncertainty about the floor (level) location as it invariably occurs with other systems. When the site has multiple levels, at least one CPU may be assigned to each level, so the device always detects and reads from the at least one CPU in the level it is on, and change as the user moves from one level to another.

Also, the system may categorize and catalog the site and allow to search for particular items, departments, offices, services, stores, etc. within the site, and accordingly direct the user from her current to her desired position.

Another valuable feature of the invention is that it enables targeted advertising and promotions according to user's mobility across the site. Likewise, important safety or emergency messages may be transmitted through the device as the situation may require.

Another important advantage is the ability to store information and readily interact with parties (stores, agencies, offices, etc.) within the site, from the site itself or at a later time from a remote location.

### OBJECT AND ADVANTAGES OF THIS INVENTION

In light of the state of the art and its shortcomings, the following are specific objects and advantages of the present invention.
1. To overcome all the limitations of the existing indoor positioning systems, and hence:
2. To provide full control of the positioning of a person or object within an enclosed environment.
3. To provide a simple, cost effective, accurate and reliable solution to the task of locating the position and tracking the mobility of a person or object within an enclosed environment.
4. To enable the detection and track the mobility of a person or object within any floor level of an enclosed three dimensional environment.
5. To help indicate the distance and trace the trajectory of a first location with respect to a second location within an enclosed environment.
6. To enable further commercial, promotional, safety etc., features by customizing text, graphics, audio, and/or video messages as the user moves within the enclosed environment.
7. To provide a detailed, and always current lay-out of the site where indoor positioning is desired. The site lay-out may be updated as often as desired.

### BRIEF DESCRIPTION OF THE DRAWINGS

FIG. 1 is a chart flow summarizing the process of the present invention.

FIG. 2 is a plan view of an example of a floor lay-out of an indoor site.

FIG. 3 is a plan view of a detail of the “Directory” feature of FIG. 2.

FIG. 4 is a schematic side view of a 3 story building.

FIG. 5 is a plan view of an example of a floor lay-out, further showing the necessary path from a first location to a second location.

### DETAILED DESCRIPTION

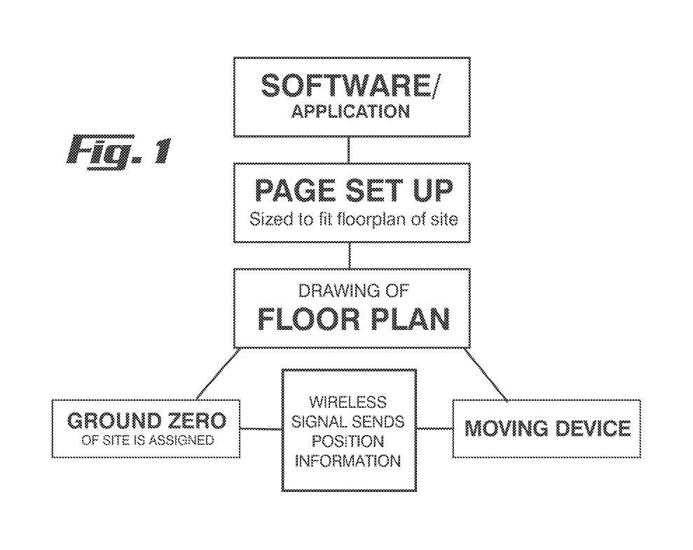

A summary of the invention is shown by chart flow of FIG. 1. A software or application is provided to manage the interaction of the central station, or central processing unit (CPU) or ground zero location with the mobile device or devices. The first step is to set up the page where the floor plan of the site is to be drawn, if the site has multiple floor levels, the page set up feature will produce multiple pages, one for each floor level. The floor plan or plans are typically prepared by the site, an agent of the site or a vendor of the invention. At this point, user installs the application or software, including the drawings of the site. Once the application is installed, the mobile device starts to exchange data wirelessly with the central station or ground zero, or CPU, or transmitter.

The data transmission may be implemented by systems known as “WiFi”, “Bluetooth®” and radio waves. A fairly new system of distance measurement using radio waves that may be adapted for this application is described on the www.instructables.com and submitted by user “Jones Electronic” on Mar. 20, 2011, entitled “Distance Measurement with Radio Waves”. This system promises a robust and reliable transmission within 1.5 km (approx. 1 mile) with an error margin of about 5 m (15 feet), and without being affected by walls or any obstacles. Also, it is widely known that radio waves do not interfere with other waves. A .pdf version of the description of this system is available at http://bit/ly/1IHdXtA.

As noted before, the page set-up may be obviated, and the outer boundaries of the drawing of the floor plan will define the size of the document.

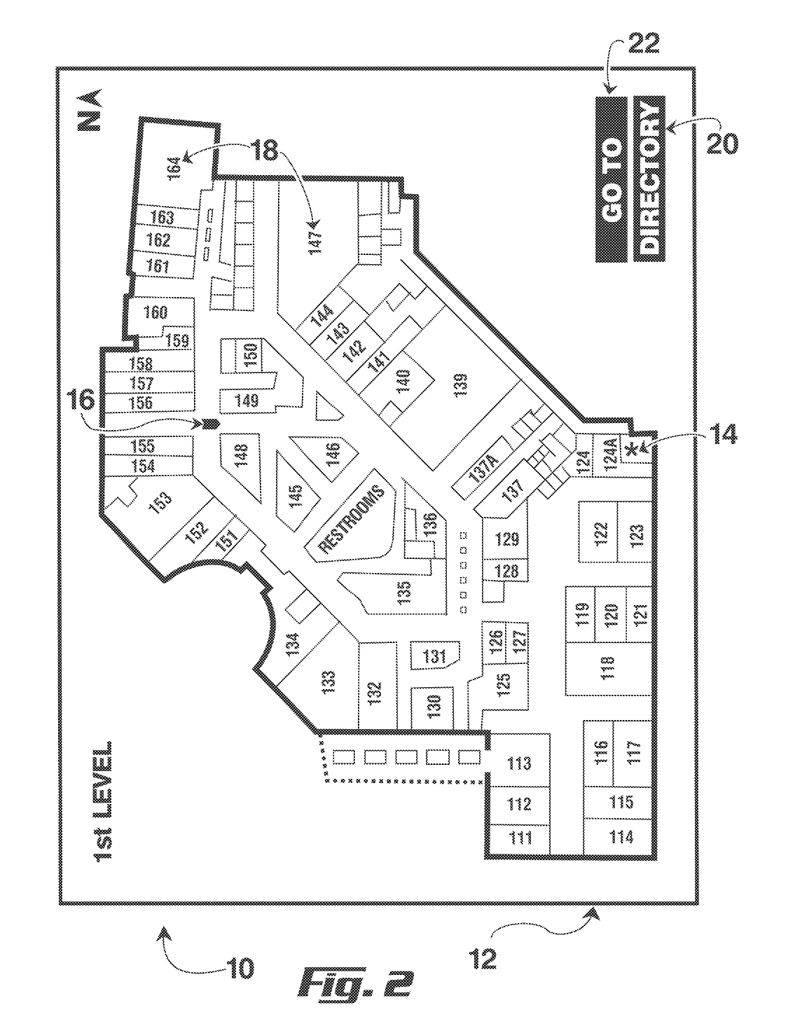

A drawing of floor plan 10 of a shopping mall is shown in FIG. 2 as it appears on the screen of the mobile device. The document is defined by page border 12. A central station, containing a central processing unit also referred to as ‘ground zero’ is indicated by asterisk 14. The mobile device location is indicated at 16. Numerals 18 identify the different establishments within the floor plan. User may discretionarily zoom in, zoom out, pan, rotate, erc., the screen or sections of the screen and may also open up menus, etc. “Directory” 20 may be opened to search for a specific establishment. Other possible features include but are not limited to information details about a specific location, advertisements, promotions, coupons, etc.

To find the location of a specific establishment, user selects the appropriate virtual button 20 marked as “GO TO” or any other suitable language. Then, the device determines the position of the new location with respect to the current location and traces the trajectory. If the new location is on another floor level, the device directs the user to the closest stairs, escalator, or elevator. Once on the destination floor level, the device continues the directions to the new location.

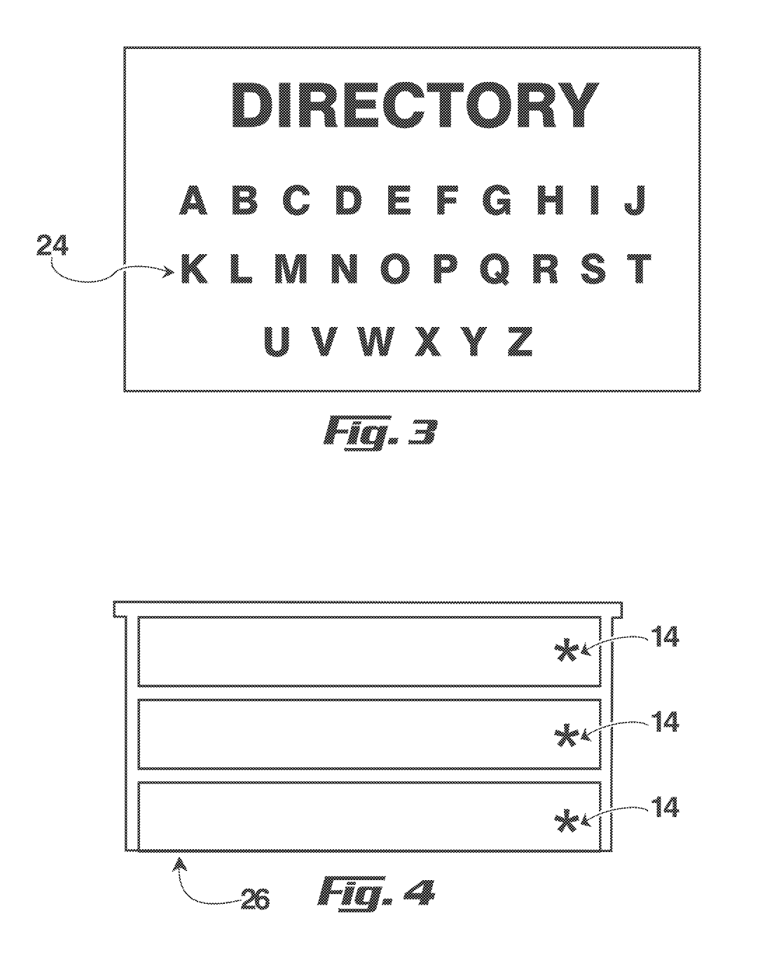

A detail of the “DIRECTORY” virtual button 22 of FIG. 2 is shown in FIG. 3, after it was opened. By clicking on appropriate initial letter, user may locate the desired establishment and obtain more information.

FIG. 4 shows in side view a schematic drawing of a 3 story budding where asterisks 14 show also in schematic fashion the position of at least one CPU, central station or ‘ground zero’ on each floor level.

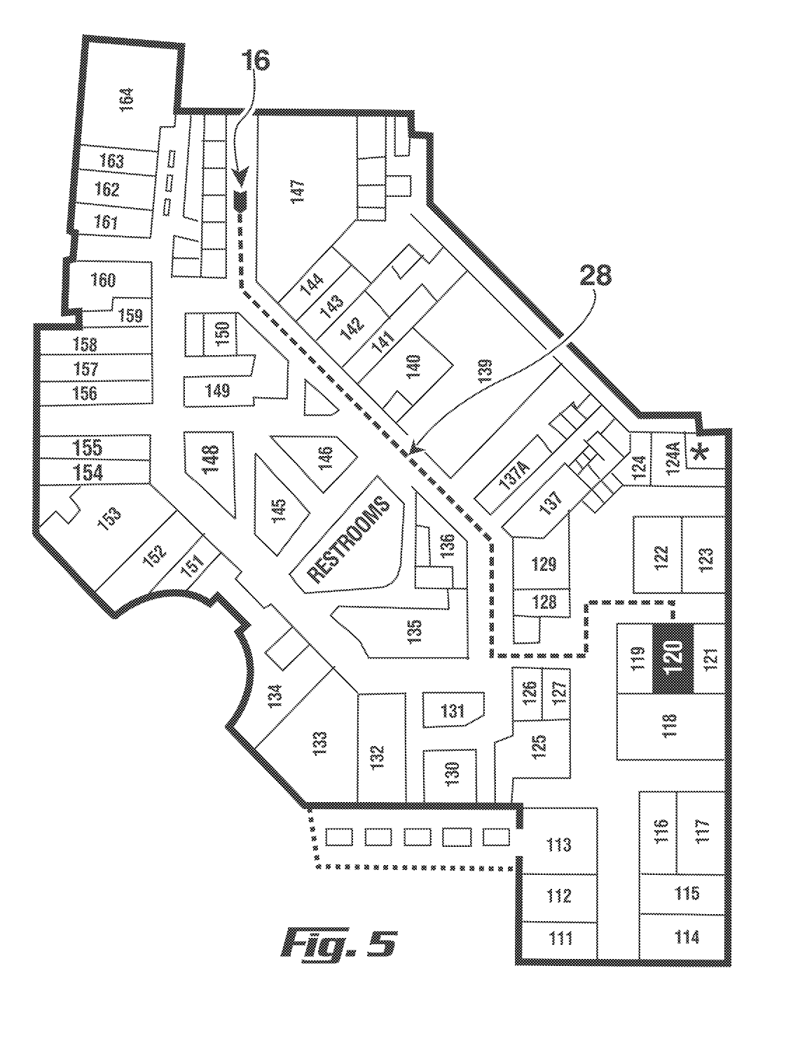

In FIG. 5, software indicates the path 28 from a current location of mobile device 16 to a new location within the same floor level. Tracking and navigating through different levels is possible by providing CPU's or beacons on each floor level, as indicated above.

It is to be understood that obvious equivalents may be applied to the foregoing disclosure and that further variations may be implemented within the scope of the invention.

I claim:

1. An indoor positioning system to track the position of at least one device within an enclosed building, comprising:
a) at least one central processing unit, located at a predefined ground zero within said enclosed building,
b) providing means to said central processing unit to wirelessly exchange positioning data with said at least one device,
c) providing displaying means to said at least one device,
d) providing software means to said at least one device,
wherein said software means have a floor plan blueprint of said enclosed building, and
wherein said software means allow to process said positioning data so as to track the position of said at least one device with respect to said central processing unit, and any other location within said enclosed building,
whereby said floor plan blueprint and the position of said at least one device within said floor plan blueprint and with respect to any other location within said floor plan blueprint is displayed on said displaying means.

2. The indoor positioning system of claim 1, wherein said enclosed building has multiple floor levels, and each of said floor levels has at least one central processing unit.

3. The indoor positioning system of claim a, wherein said means to wirelessly exchange positioning data in clause b) is radio waves.

4. The indoor positioning system of claim 1, wherein said at least one device is a wireless telephone.

5. The indoor positioning system of claim 1, wherein said central processing unit is located on said at least one device, and said indoor positioning system further comprises at least one beacon defining a ground zero on said enclosed building so said at least one device can exchange data with said at least one beacon.

6. An indoor positioning network comprising:
a) at least one central processing unit to be placed on a predetermined location within an indoor site,
b) at least one wireless device, having a display unit, and further having a tracking software capable of exchanging positioning data wirelessly with said central processing unit and further having a drawing of the floor plan of said indoor site,
so the positioning and mobility of said at least one wireless device are indicated on said drawing of the floor plan and displayed on said display unit, and the distance and trajectory of the position of said device with respect to a different location may be digitally quested and the result displayed on said display unit.

7. The indoor positioning network of claim 6, wherein said indoor site has multiple levels, and at least one central processing unit is placed on each of said multiple levels.

8. The indoor positioning network of claim 6, wherein said at least one wireless device is a telephone.

9. A process of operating a data locating system for ascertaining the physical position of an object within an indoor construction, and to further ascertain the distance and trajectory of said object's location with respect to a different location within said indoor construction, comprising:
a) at least one mobile device, having a software with a blue print of at least one floor plan of said indoor construction, and further having a viewing display unit,
b) at least one central station located at one fixed position within said at least one floor plan of said indoor construction, having the ability to wirelessly detect the location of said at least one mobile device in an X-Y coordinates map, on said at least one floor plan of said indoor construction,
whereby said at least one mobile device depicts the location of said at least one mobile device relative to said at least one floor plan indoor construction and the distance and trajectory of said at least one mobile device with respect to a different location within said indoor construction in said viewing display unit.

10. The process of operating the data locating system of claim 9, wherein said indoor construction has multiple floor levels, wherein said process of operating a data locating system further comprises at least one central station located at one fixed position within each of said multiple floor levels, whereby the location of said mobile device on a z coordinate is ascertained.

11. The process of operating the data locating system of claim 9, wherein said mobile device is a wireless telephone.
